(19) United States
(12) Patent Application Publication
(10) Pub. No.: US 2023/0070745 A1
(43) Pub. Date: Mar. 9, 2023

(54) SYSTEM AND METHOD FOR STOPPED VEHICLE MOVEMENT DETECTION

(71) Applicants: mohammad shafikul huq, HAMTRAMCK, MI (US); shakura quabili, HAMTRAMCK, MI (US)

(72) Inventors: mohammad shafikul huq, HAMTRAMCK, MI (US); shakura quabili, HAMTRAMCK, MI (US)

(73) Assignee: mohammad shafikul huq, HAMTRAMCK, MI (US)

(21) Appl. No.: 17/881,598

(22) Filed: Aug. 5, 2022

Related U.S. Application Data
(60) Provisional application No. 63/241,065, filed on Sep. 6, 2021.

(51) Int. Cl. B60W 50/16

(52) U.S. Cl. CPC B60W 50/16; B60W 2050/146

(57) ABSTRACT

The presented invention is a system and method for reposition detection of a shut down vehicle. The system gives alert when a parked vehicle has gone through incidences such as tire pressure gone down, flat tire, vehicle move by a small amount, or a complete vehicle reposition after it was parked at a place. In preferred embodiments, the system comprises at least an optical sensor, or LiDAR, or RADAR sensor, or their combination in any plurality and/or a GPS sensor, with all sensors mounted on the vehicle to capture images, distances, or positions of objects around the vehicle and/or GPS location of the vehicle, a controller with microprocessor and memory, and alert systems capable of playing or displaying alerts of audible, visual, and haptic formats. The method captures images, distances, or positions of objects around the vehicle and/or GPS location of the vehicle, which together is called sensor data; the said sensor data is processed to obtain analytics and scene features that are saved in memory before the vehicle shuts down. When the vehicle turns ON the next time, the method captures sensor data again and process the data to obtain analytics and scene features and then compares the current analytics and scene features with the analytics and scene features captured during the last vehicle shut down cycle. The comparison finds out if a translation and rotation to the vehicle has happened by a small amount or the vehicle has been completely repositioned. From the amount of translation and rotation, the method decides if the vehicle has low tire pressure, flat tire, or if the vehicle has been completely repositioned, or moved by a small amount and generates audible, visual, haptic signals accordingly to send to alert systems. The vehicle also generates low tire pressure, flat tire, or vehicle reposition signal to send to the vehicle system.

### FIELD OF THE INVENTION

The present invention relates to Advanced Driver Assist Systems (ADAS) or Automated Driving (AD) features. The invention is a feature for alerting a driver or the vehicle system of vehicle movement that a vehicle may have gone through after parking and vehicle shut down; the feature is capable of giving a driver alert or providing the vehicle system a signal when a vehicle has gone through incidence such as tire pressure gone down, or flat tire, and vehicle reposition by a small amount or complete repositioning. Signals of the said incidences are sent to alert systems or the vehicle system when the parked vehicle is turned ON. The proposed system and method may use already existing sensors mounted on vehicle to implement the features.

### CROSS REFERENCE TO RELATED APPLICATION

This application is a continuation application of U.S. Provisional Pat. Application No. 63/241065, filed Sep. 06, 2021 with conformation number 2635, the contents of which are incorporated herein by reference almost in their entirety, with claims unchanged.

### BACKGROUND

A parked vehicle may experience several incidences: tire pressure gone down, flat tire, or the vehicle moved by a small amount or complete repositioning. All these should be revealed to the driver or the vehicle system the vehicle is turned ON next time.

There are tire pressure detection sensors and methods that use wheel-speed based pressure detection. These technologies have their own merits and demerits. Wheel-speed based systems are found to be easier to maintain since there are no battery life concerns and the fact that sensors are not exposed to tire mounting and roadway hazards; they fail to detect low pressure or flat tire if the vehicle is not moving. Pressure-sensor based systems are expensive and prone to damage during tire mounting or replacement. If the battery is drained, tire pressure will not be measured.

The above technologies, on the other hand, can’t tell us if a vehicle has been moved while it was SHUT DOWN. If a vehicle is moved after SHUT DOWN, GPS sensor can tell the vehicle system that the vehicle has moved only if GPS signal was available during both turn ON and SHUT DOWN cycles of the vehicle.

The proposed technology offers two folds of benefit. First, it works as a redundant method for low tire pressure or flat tire detection after a parked vehicle is turned ON and second, it detects if a vehicle has moved after it was SHUT DOWN. The latter is needed for vehicle with automated driving that needs to start an exhaustive search for vehicle localization, instead of a computationally inexpensive incremental search when a vehicle does not move as much. The latter also helps determine potential theft of a vehicle and delivers signal to remote mobile device.

### BRIEF SUMMARY OF THE INVENTION

The presented invention is a system and method for reposition detection of a shut down vehicle. The system gives alert when a parked vehicle has gone through incidences such as tire pressure gone down, flat tire, vehicle move by a small amount, or a complete vehicle reposition after it was parked at a place. In preferred embodiments, the system comprises at least an optical sensor, or LiDAR, or RADAR sensor, or their combination in any plurality and/or a GPS sensor, with all sensors mounted on the vehicle to capture images, distances, or positions of objects around the vehicle and/or GPS location of the vehicle, a controller with microprocessor and memory, and alert systems capable of playing or displaying alerts of audible, visual, and haptic formats. The method captures images, distances, or positions of objects around the vehicle and/or GPS location of the vehicle, which together is called sensor data; the said sensor data is processed to obtain analytics and scene features that are saved in memory before the vehicle shuts down. When the vehicle turns ON the next time, the method captures sensor data again and process the data to obtain analytics and scene features and then compares the current analytics and scene features with the analytics and scene features captured during the last vehicle shut down cycle. The comparison finds out if a translation and rotation to the vehicle has happened by a small amount or the vehicle has been completely repositioned. From the amount of translation and rotation, the method decides if the vehicle has low tire pressure, flat tire, or if the vehicle has been completely repositioned, or moved by a small amount and generates audible, visual, haptic signals accordingly to send to alert systems. The vehicle also generates low tire pressure, flat tire, or vehicle reposition signal to send to the vehicle system.

### BRIEF DESCRIPTION OF THE DRAWINGS

System and method of the present invention are illustrated as an example and are not limited by the figures of the accompanying diagrams and flowcharts, in which:

FIG. 1 - FIG. 1 depicts a system comprising various sensors, signal sources, processing units, vehicle system, and alert systems.

FIG. 2 - FIG. 2 depicts a flowchart that describes how different steps and routines are applied one after another sometimes in sequence and/or in loop at times to generate audible, visual, haptic alert signals, or vehicle reposition signal related to low tire pressure, flat tire, vehicle repositioning by a small amount, or a complete movement of the vehicle.

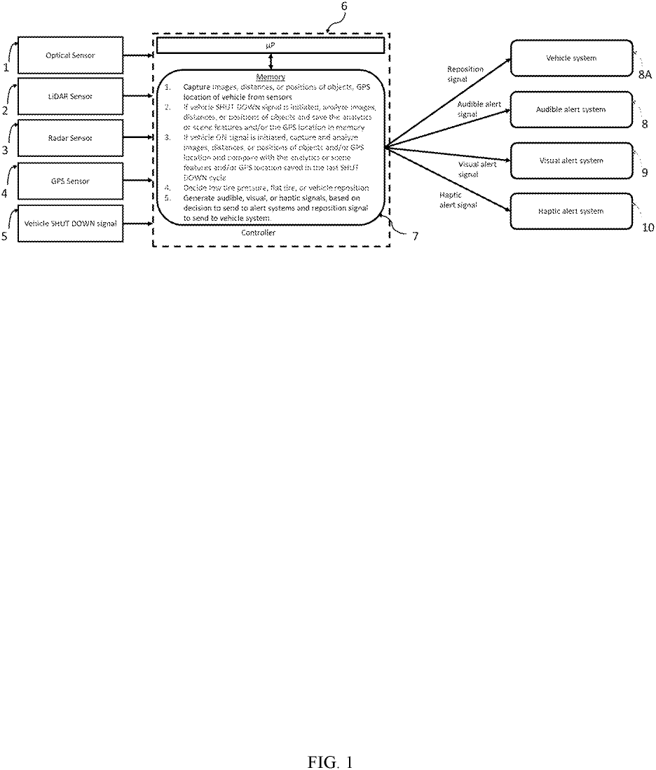

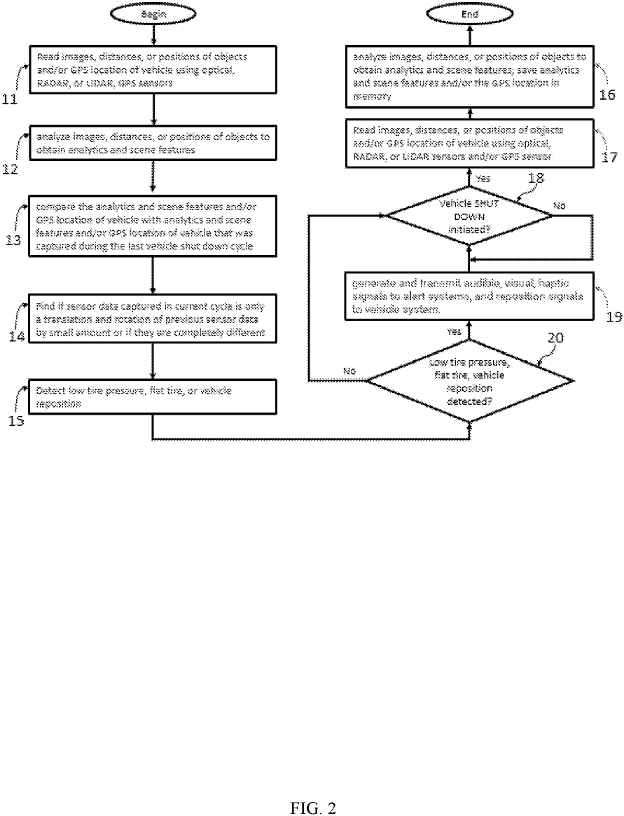

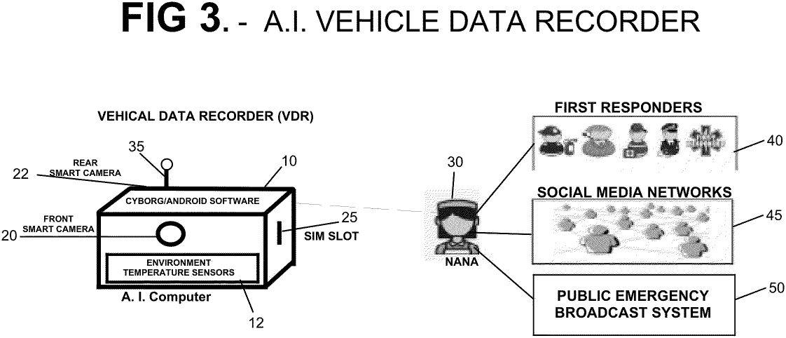

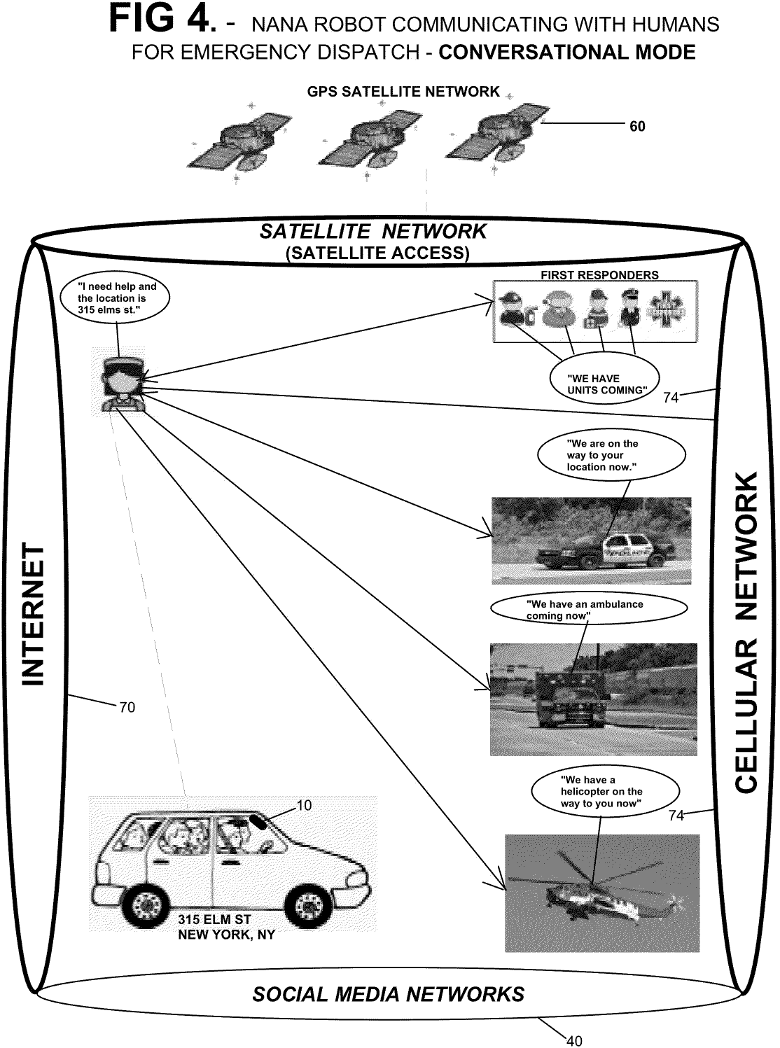

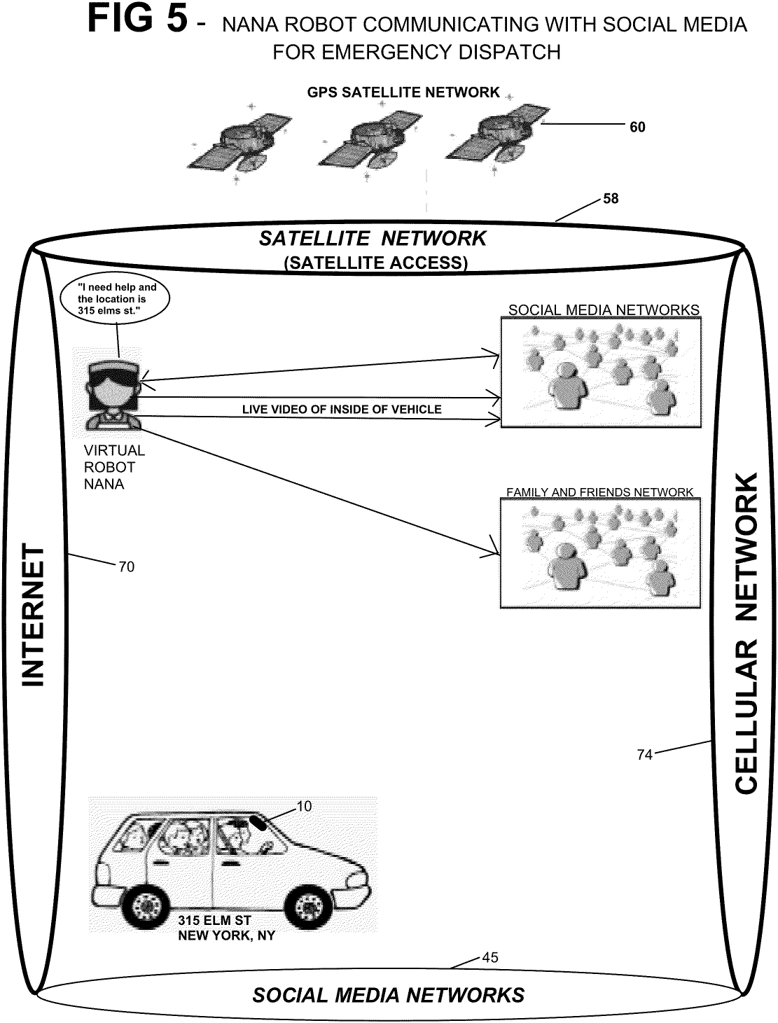

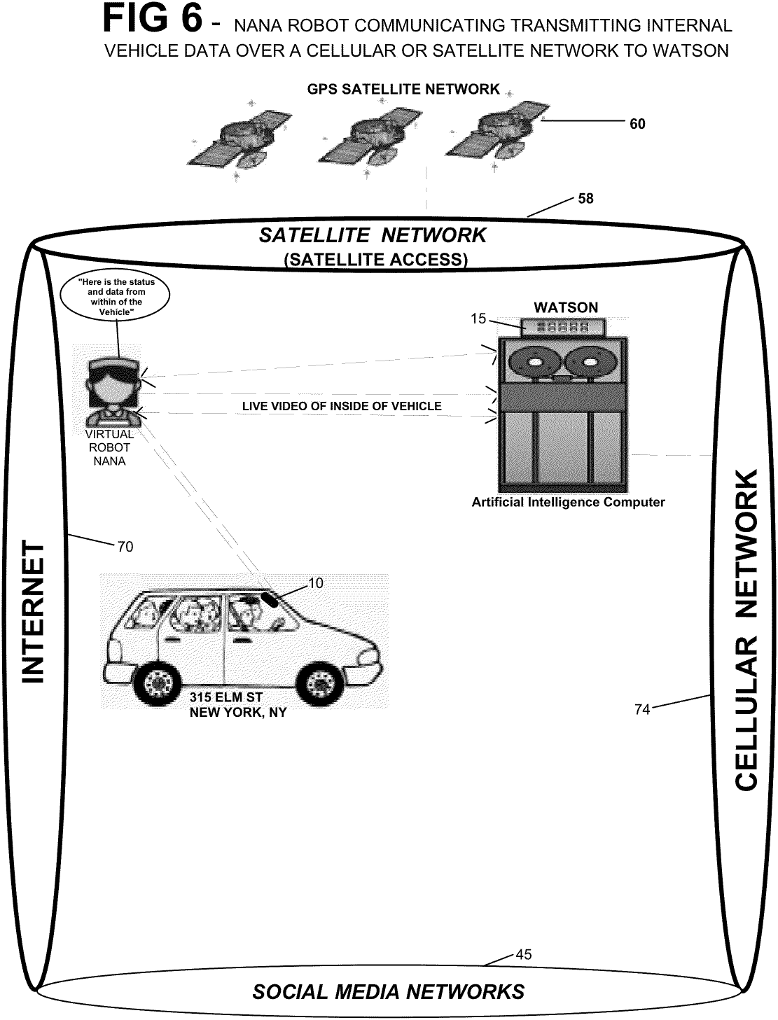

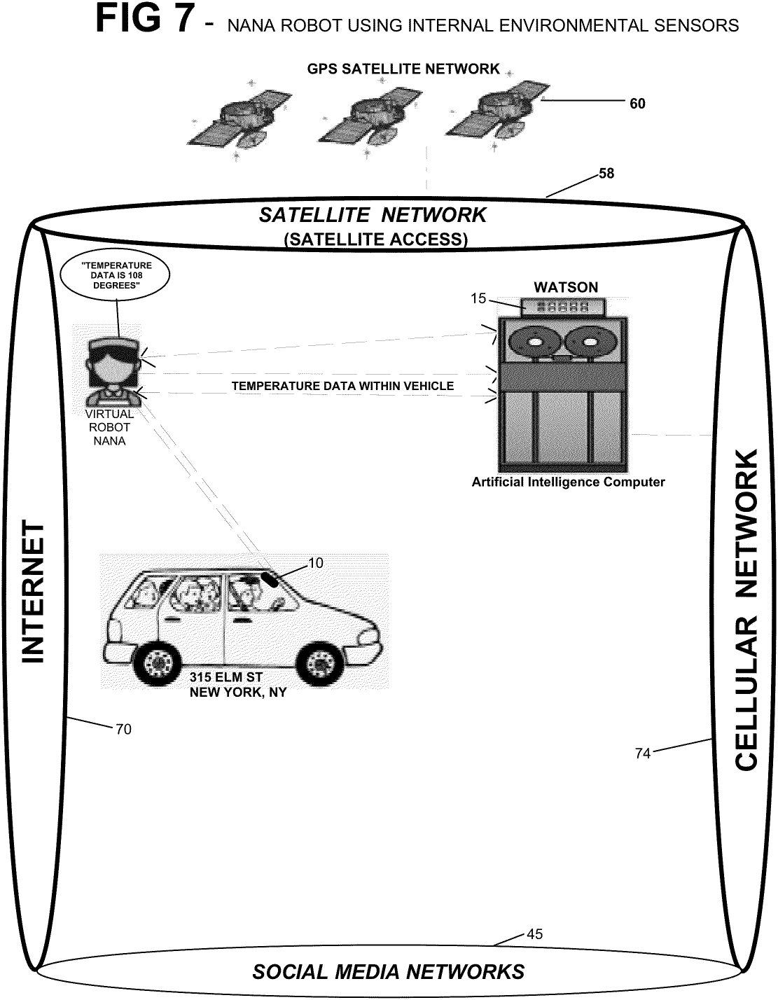

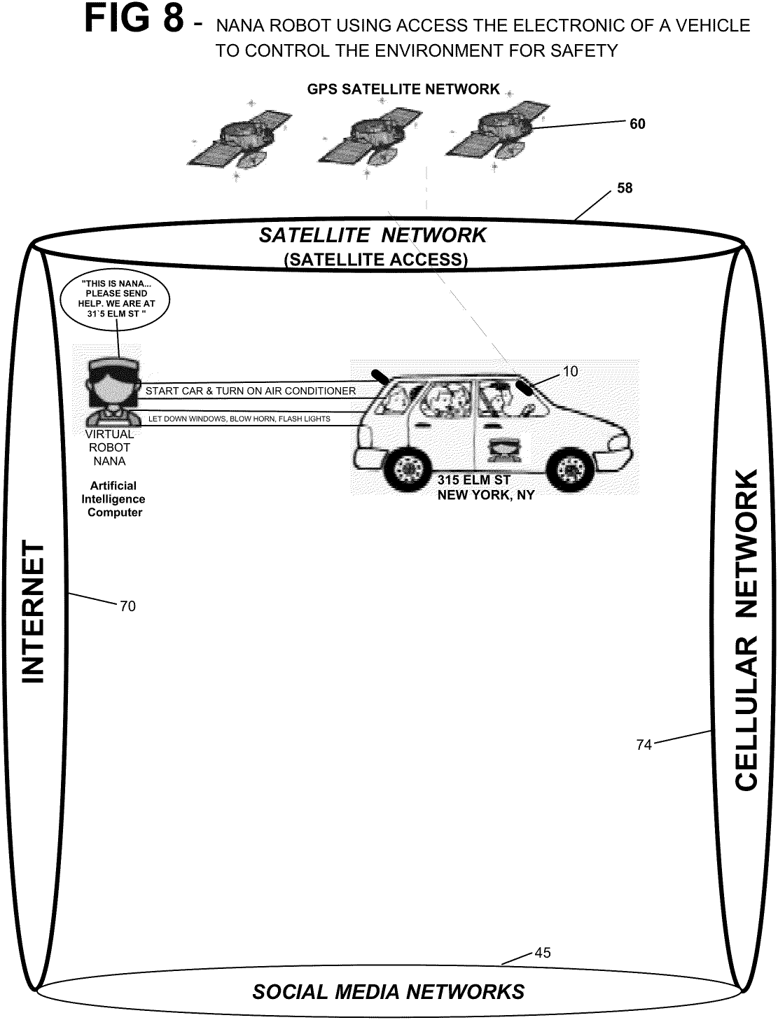

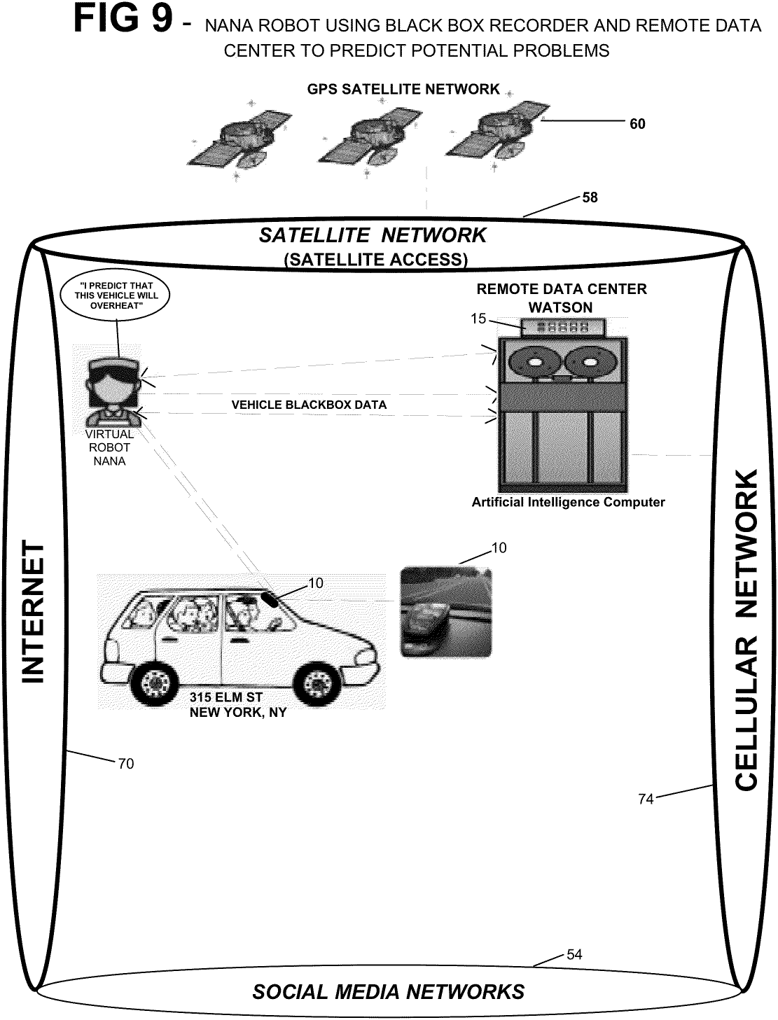

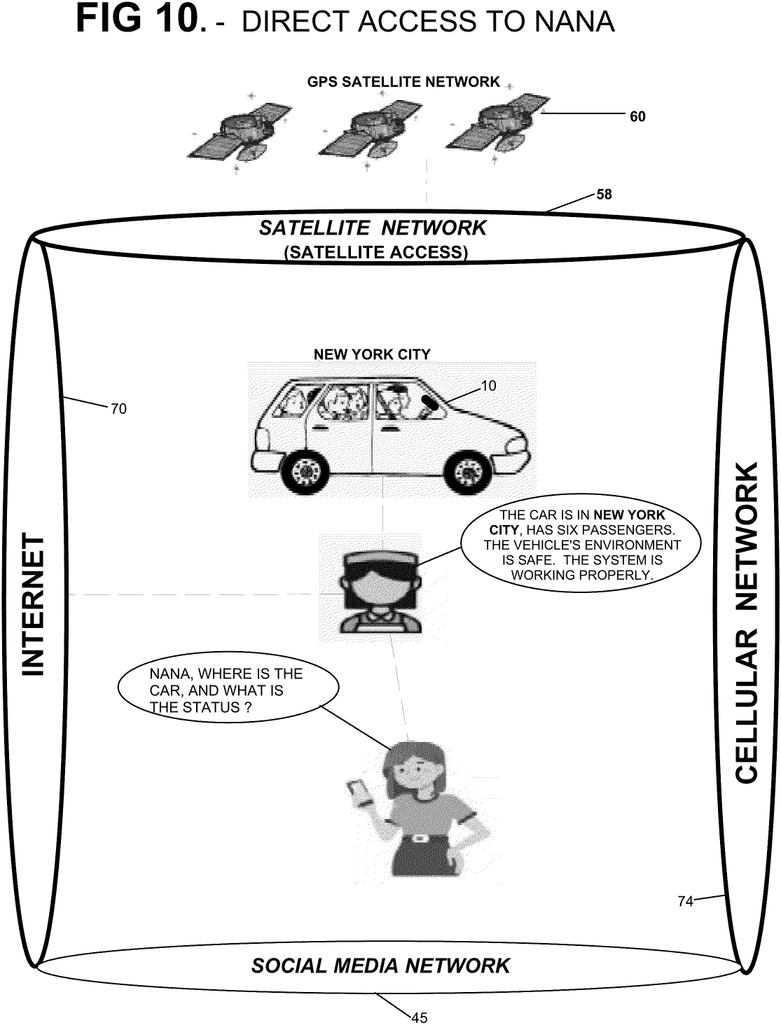

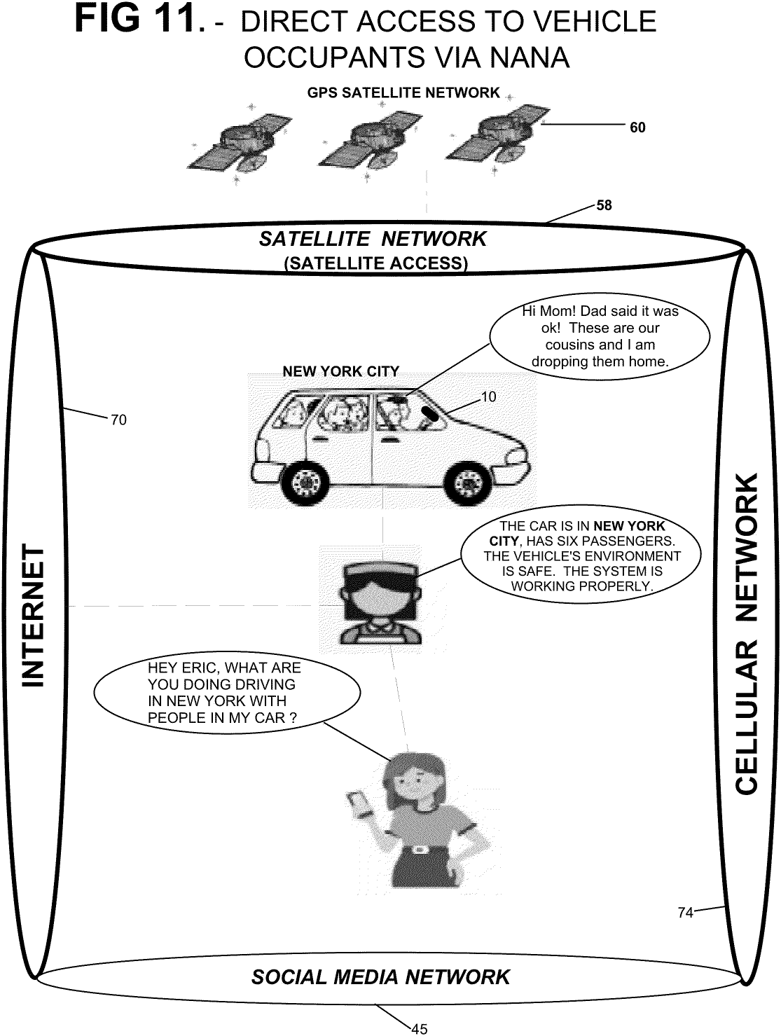

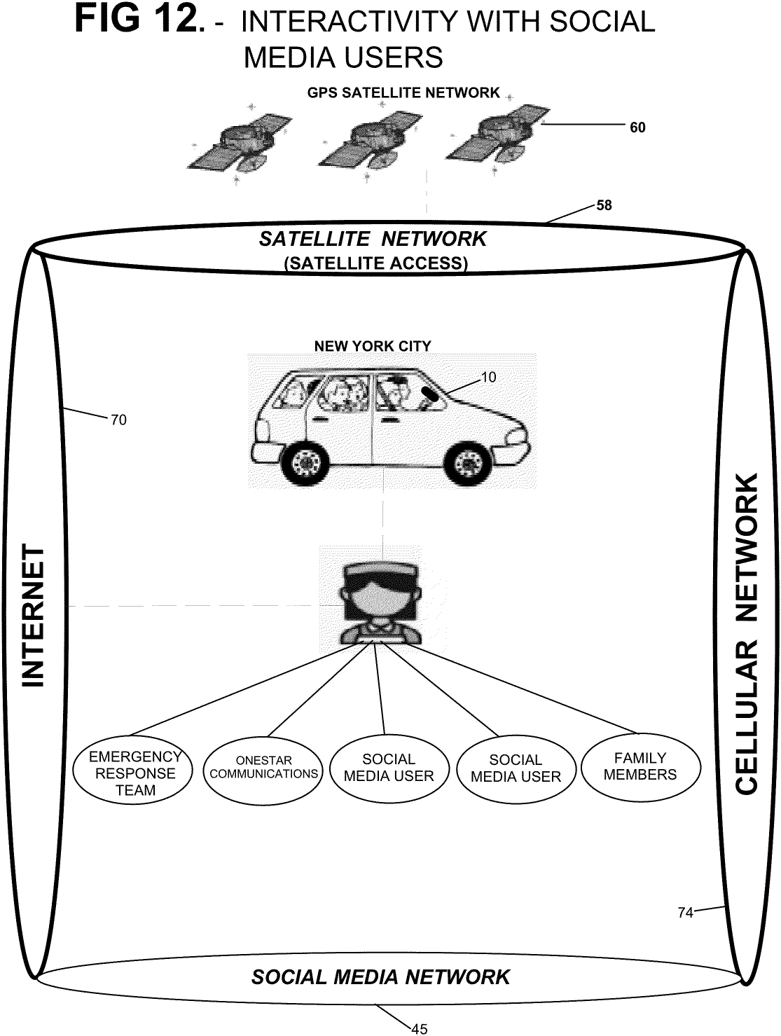

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

The present invention is a system and method for parked vehicle reposition detection. The system gives alert when a vehicle has gone through an incidence such as tire pressure gone down, flat tire, vehicle move by a small amount, or a complete vehicle reposition after it was parked at a place. In preferred embodiments, the system comprises at least one optical sensor 1, or LiDAR 2, or RADAR 3 sensor, or their combination in any plurality and/or a GPS sensor 4, with all sensors mounted on the vehicle to capture images, distances, or positions of objects around the vehicle and/or GPS location of the vehicle, vehicle SHUT DOWN signal source 5, a controller 6 with microprocessor and memory 7, alert systems 8, 9, 10 capable of playing or displaying alerts of audible, visual, and haptic formats, vehicle system 8A receiving vehicle reposition signal.

The method reads or captures images, distances, or positions of objects around the vehicle and/or GPS location of the vehicle 11, 17, which together is called sensor data; the said sensor data is processed to obtain analytics and scene features that are saved in memory if vehicle is scheduled for a shut down 16. If the vehicle is turned ON later, the method reads or captures sensor data again 11 and processes the data to obtain analytics and scene features 12 and then compares the current analytics and scene features with the analytics and scene features captured during the last vehicle shut down cycle 13, 18. The comparison finds out if a translation and rotation to the vehicle has happened by a small amount or the vehicle has completely been repositioned 14. From the amount of translation and rotation, the method decides if the vehicle has moved due to low tire pressure, or flat tire, or if the vehicle has been completely repositioned, or moved by a small amount. The method generates audible, visual, haptic signals accordingly to send to alert systems 15, 20, 19. The vehicle also generates low tire pressure, flat tire, or vehicle reposition signals to send to the vehicle system 19.

1. A system for use on a vehicle to give the driver an alert of low tire pressure, potential flat tire situation, vehicle repositioning, and potential vehicle theft when the driver turns on the vehicle, with the said system comprising:
at least one optical sensor, or LiDAR, or RADAR sensor, or their combination in any plurality and/or a GPS sensor, with all sensors mounted on the vehicle to capture images, distances, or positions of objects around the vehicle and/or GPS location of the vehicle;
a controller to analyze the said images, distances, or positions of objects; and
audible, visual, or haptic alert systems and vehicle system.

2. The system as defined in claim 1, wherein the said controller determines if the vehicle is stopped.

3. The system as defined in claim 1, wherein the said controller further determines from the said images, distances, or positions of objects in claim 1 if vehicle has low tire pressure or the vehicle has been repositioned or moved.

4. The system as defined in claim 1, wherein the said controller further generates audible, visual, and haptic alert signals.

5. The said visual alert signal as defined in claim 1 is either optical or textual in nature, where the signal is delivered to a visual alert system.

6. The said audible, visual, or haptic alert systems as defined in claim 1 could be alert systems installed on the ego vehicle or on a mobile device connected through wired or wireless media.

7. The said audible alert signal as defined in claim 1 could be a distinct sound or in any other format.

8. A method to give the driver or the vehicle system an alert or signal after the vehicle turns ON and if the vehicle has experienced a lower tire pressure, a flat tire, or repositioning by a small amount, or complete vehicle reposition compared to its previous position and orientation at the time of its last shut down cycle, with the said method comprising the steps:
capturing images, distances, or positions of objects using optical, RADAR, or LIDAR sensors installed on the vehicle, which are called sensor data and/or capturing GPS location of the vehicle;
processing the said sensor data to obtain analytics and scene features, save the analytics and scene features and/or the GPS location in memory if vehicle is scheduled to shut down, or if vehicle is turned ON, compare the analytics and scene features with analytics and scene features and/or GPS location that was captured during the last vehicle shut down cycle;
finding out if the said sensor data captured in current cycle is only a translation and rotation of previous sensor data by a few inches or if they are completely different;
deciding if the vehicle has low tire pressure, flat tire, or if the vehicle has been completely repositioned, or moved by a small amount;
generating audible, visual, haptic, and vehicle reposition signals if low tire pressure, flat tire, and/or complete vehicle repositioning or movement is discovered; and
sending audible, visual, haptic signals to alert systems, and/or vehicle reposition signals to vehicle system.

9. The said vehicle reposition signal as defined in claim 8 could be in binary such as repositioned or not or in exact or approximate amount of translation and orientation of the vehicle.
